(19) United States
(12) Patent Application Publication
(10) Pub. No.: US 2021/0219773 A1
(43) Pub. Date: Jul. 22, 2021

(54) Method of controlling the outflow of the amount of water required to form a given dose of a beverage obtained from ground coffee as it is being dispensed into a cup and apparatus for carrying out such method

(71) Applicant: Gruppo Cimbali S.p.A., Binasco MI (IT)

(72) Inventors: Mario DALLERA, Binasco MI (IT); Luca Attilio Maria GATTI, Binasco MI (IT)

(21) Appl. No.: 17/154,144

(22) Filed: Jan. 21, 2021

(30) Foreign Application Priority Data
Jan. 22, 2020 (IT) 102020000001159

(51) Int. Cl. A47J 31/56; A47J 31/40; A47J 31/46

(52) U.S. Cl. CPC A47J 31/56; A47J 31/461; A47J 31/469; A47J 31/402

(57) ABSTRACT

A method and an apparatus are described for controlling and regulating the amount of the water required to form a given dose of a beverage obtained from ground coffee, as it is being dispensed into a cup, so that the dispensed dose will match the target dose. The apparatus comprises, in a machine for preparing coffee-based beverages, a panel for selecting the type of beverage to be dispensed into a cup, a hot water generator, an electric pump, a brewing unit, a flow meter located between the electric pump and the brewing unit, the electric pump being provided to feed hot water to the brewing unit, a valve device placed on a hydraulic connection between the electric pump and the brewing unit to shut off or actuate delivery of hot water, an electronic control unit, and a member for weighing the cup and its contents dispensed by the brewing unit. The electronic control unit is configured to shut off delivery of hot water to the brewing unit as the weighing member receives a signal corresponding to the stored stop weight value which corresponds to the total weight of the type of beverage selected on the selection panel of the machine minus the residual weight.

### FIELD

The present invention relates to a method of controlling, in a machine for preparing coffee-based beverages, the outflow of the amount of the water required to form a given dose of a beverage obtained from ground coffee, as it is being dispensed into a cup, so that the dispensed dose will actually match the selected target dose.

In coffee-based beverage preparation, machines are known to be widely used in which the beverage-preparing apparatus consists of a hot water generator, an electric pump, a brewing unit, and a valve unit located between the electric pump and the brewing unit, to intercept the flow of hot water from the brewing unit and shutting it off when a given amount of beverage has been reached in the cup.

For this purpose, in one technology of the prior art, coffee machines also include either a device for determining the weight of the dose in the cup or a flow meter for measuring the volume flow rate, that can be converted to mass flow rate if needed, of the flow into the cup, to determine in the overall amount of the dose.

Coffee machines also include a control unit that manages the various operating steps and hence the entire beverage preparation process.

### BACKGROUND

As described in DE 3,332,236 A1, the beverage preparation machine comprises a scale on which the beverage collecting cup is placed. The scale is connected with a microprocessor which detects its signal. When the beverage in the cup reaches the predetermined weight, as stored in the microprocessor, the corresponding signal and the microprocessor stop delivery of the beverage-forming water by shutting off a valve member located in the relevant conduit.

In a further technique of the prior art, as disclosed for instance in EP 3,162,256 A1, in WO 2016 147 026 A1 and in WO 2015 055 342 A1, beverage dispensing is stopped when the weight of the liquid in the collecting cup is such that the brew ratio, i.e. the ratio of the dose of ground coffee powder that has been used to make the beverage to the weight of the liquid coffee in the cup, reaches a predetermined value, that is stored in the electronic control unit of the machine.

The common principle underlying the method of the prior art, as previously documented, lies in that delivery of beverage-forming water is stopped as soon as a particular value of a given parameter stored in the control unit of the machine is attained, without considering that part of the beverage-forming water is contained in the hydraulic circuit downstream from the location in which the flow is shut-off, and in particular in the coffee panel accommodated in the filter as well as in the dispensing conduits of the portafilter, and hence flows into the cup as a residue, thereby altering the desired target dose.

Furthermore, since water delivery is always shut-off by a three-way valve member, when water flow is shut off, the water downstream from the valve member is not entirely channeled toward the drain to be drained off, as a part of it may flow out toward the cup and a part of it, referred to as saturation water, is still present in the apparatus downstream from the valve member because it was received therein after a given time since the start of delivery.

As a result, the amount of beverage that is actually in the cup does not match the desired target amount, as defined according to the selected type of beverage.

### SUMMARY

The difficulties and drawbacks associated with previous approaches are addressed in the present subject matter as follows.

In one aspect, the present subject matter provides a method of controlling the outflow of the amount of water required to form a given dose of a beverage obtained from ground coffee, accommodated in a filter, as it is being dispensed into a cup. The method comprises a step of determining the total or target weight PT of the beverage to be dispensed into the cup, and a step of determining the residual weight PR flowing into the cup after brewing water feeding has been stopped. The method also comprises an additional step of determining a stop weight PS at which the flow of the beverage brewing water is shut off, the stop weight PS being equal to PT minus PR and being stored in an electronic control unit to control brewing water shut off.

In another aspect, the present subject matter provides an apparatus for carrying out a method of controlling the outflow of an amount of water required to form a given dose of a beverage obtained from ground coffee. The apparatus comprises in a machine for preparing coffee-based beverages, a panel for selecting the type of beverage to be dispensed into a cup, a hot water generator, an electric pump, a brewing unit, and a flow meter located between the electric pump and the brewing unit. The electric pump is provided to feed hot water to the brewing unit. The apparatus also comprises a valve device placed on a hydraulic connection between the electric pump and the brewing unit to shut off or actuate delivery of hot water. The apparatus also comprises an electronic control unit, and a member for weighing the cup and its contents dispensed by the brewing unit. The electronic control unit is configured to shut off delivery of hot water to the brewing unit as the weighing member receives a signal corresponding to the stored stop weight value PS which corresponds to the total or target weight PT of the type of beverage selected on the selection panel of the machine, minus the residual weight PR.

As will be realized, the subject matter described herein is capable of other and different embodiments and its several details are capable of modifications in various respects, all without departing from the claimed subject matter. Accordingly, the drawings and description are to be regarded as illustrative and not restrictive.

### BRIEF DESCRIPTION OF THE DRAWINGS

The invention will be now further described with reference to a preferred embodiment thereof, given by way of illustration and without limitation, and shown in the annexed drawings, in which:

FIG. 1 shows a functional diagram of the components of the apparatus for carrying out the method of the invention.

### DETAILED DESCRIPTION OF THE EMBODIMENTS

The object of the present invention is to provide a method to stop delivery of the beverage-forming water as soon as a given amount of coffee has been dispensed in the cup, that also accounts for coffee residue that follows, so that the desired target dose is not exceeded in the cup. A further object of the invention is to provide an apparatus that can fulfill the need to obtain the exact desired dose of coffee in the cup, matching the target dose defined by the type of coffee selected and set in the coffee machine.

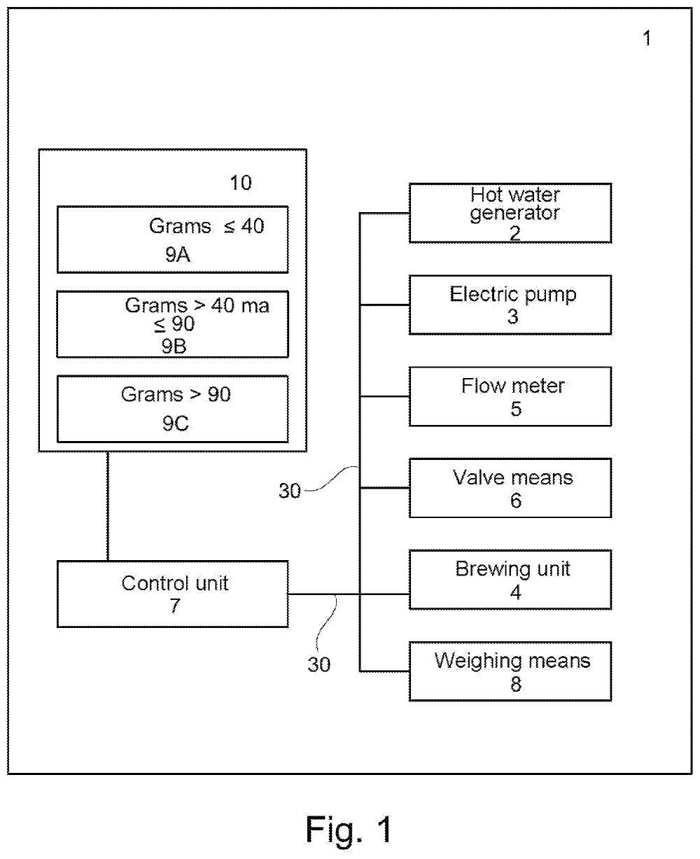

Referring to FIG. 1, the apparatus, generally referenced 1, comprises a hot water generator 2, an electric pump 3 which connects, via a conventional hydraulic connection, the hot water generator 2 to the brewing unit 4 in which the coffee beverage is formed from a predetermined dose of coffee, ground with a given particle size, and accommodated in a conventional filter, not shown.

The prepared beverage is collected in a conventional cup, not shown in the schematic drawing of FIG. 1.

The hydraulic connection 30 has a flow meter device 5 and a valve device 6 therein, the latter being used to permit or shut off the flow of hot water from the generator 2, as controlled by a conventional electronic control unit, as shown in block 7, in which the types of beverage to be dispensed into the cup are stored in the form of specific weight or volume dose measures.

Conventionally, the valve device 6 is a three-way valve, one way being directed toward the drain of the machine.

In combination with the brewing unit 4, the apparatus of the invention has a weighing unit 8 which senses the value of the amount of beverage which, after being dispensed by the brewing unit 4, flows into the collecting cup.

This weight value of the amount of beverage received in the cup, as sensed by the weighing member 8, is addressed to the control unit 7 where it is compared with the desired value, as stored therein, for the dose corresponding to the selected type of beverage.

The beverage type is selected by means of the push-buttons 9A, 9B, or 9C of the control panel 10 of the machine 1.

If the value stored in the electronic control unit 7 matches the value sent by the weighing unit 8, as sensed in the beverage collecting cup, then the control unit 7 acts on the valve device 6 to shut off the flow of hot water to the brewing unit 4. However, since an amount of brewing water is present downstream from the flow shut-off location, i.e. downstream from the valve device 6, namely inside the coffee panel accommodated in the filter, once the valve device 6 has been closed, such amount flows into the cup as a residue, and alters the final dose.

Therefore, since the final dose would no longer match the desired dose, according to the invention, the electronic control unit 7 is designed to issue the command to shut off the flow of hot brewing water, while also accounting for the residual coffee that, since the time delivery was stopped, has still reached the cup.

This will obviate the drawback of the desired target dose being exceeded.

Generally, with PR designating the residual weight which, after shutting off water delivery, is still added to the amount of beverage that has already been received in the cup and PT designating the total or target weight of beverage that is expected to be in the cup for the given type of beverage desired and selected on the panel 10 of the machine 1, the stop weight PS of the beverage in the cup, at which the electronic control unit 7 must stop delivery of brewing water by acting on the valve device 6, is represented by the formula (I):

PS=PT−PR (I)

The residual weight PR in the above formula shall be deemed to consist of at least one component, PSAT, known as saturation component, which is measured and expressed in weight units by the flow meter device 5 of the apparatus of FIG. 1 in the time interval elapsing from the start of delivery to the fall of the first drops of coffee into the cup. Nevertheless, in practice, the residual weight PR also comprises a further component, PR1, which represents the water contained in the entire hydraulic system downstream from the three-way valve unit, when the latter is closed, and is not channeled through the third way connected to the drain and eventually flows into the cup.

Therefore, this component PSAT of the residual weight PR consists of a dynamic value because it is determined of the conditions of the dose of ground product.

Changes in the dose, particle size, moisture content and aging of the grounds will lead to changes in the PSAT value because the first coffee drops fall into the cup at different times and hence also to changes in volume measurement, possibly expressed by weight, performed by the flow meter 5 and sent to a central processing unit (CPU) or electronic control unit.

While the component PR1 of the residual weight PR also changes according to the hygroscopic degree and the particle size of the ground coffee panel, it mainly depends on the configuration of the hydraulic circuit downstream from the valve device 6.

Therefore, whether the residual part PR1 of the residual weight PR can be neglected or not depends on the type of recipe with which the selected beverage is to be made.

The Applicant found that, for a beverage type consisting of a total weight or target PT ranging from 40 to 90 grams of liquid such as, for example, double espresso, long espresso, short filter coffee, the residual weight value PR for determining the stop weight PS should be deemed to be generally equal to 0.1×PSAT whereas, for a beverage type consisting of a total weight or target PT exceeding 90 grams of liquid, such as for example American coffee, coffee creams and the like, the value of the residual weight PR for determining the stop weight PS should be deemed to be generally equal to 0.16×PSAT.

Only when beverage type selected for dispensing has a total or target weight PT of less than 40 grams of liquid, such as in the case of concentrated espresso, double concentrated espresso, long espresso, is the value of the residual weight PR calculated at the time the weight of the coffee in the cup reaches a predetermined percentage of the total or target weight PT of the beverage to be dispensed and the residual weight value PR is equal to the value of the total weight of the water dispensed to that time, minus the saturation weight PSAT minus the weight of the coffee in the cup.

In particular, the aforementioned percentage by weight is selected at a value ranging from 60% to 75% of the target weight PT, and preferably 70%.

This is possible and practically acceptable since the delivery flow through the coffee panel accommodated in the filter may be considered a steady-state fluid flow, not exposed to turbulence, unlike types involving higher total weights for the beverage to be dispensed.

It will be understood from the foregoing that the control unit 7 must be configured to store, for each total weight or target weight PT of the type of beverage selected on the operating panel 10 of the coffee machine, a corresponding stop weight PS. Thus, when this weight is attained in the coffee dispensed in the cup, the weighing unit 8 notifies the control unit 7 and the latter stops delivery of hot brewing water, to allow the total weight PT to be reached by further addition of an amount of liquid corresponding to the residual weight PR in the cup.

Many other benefits will no doubt become apparent from future application and development of this technology.

All patents, applications, standards, and articles noted herein are hereby incorporated by reference in their entirety.

The present subject matter includes all operable combinations of features and aspects described herein. Thus, for example if one feature is described in association with an embodiment and another feature is described in association with another embodiment, it will be understood that the present subject matter includes embodiments having a combination of these features.

As described hereinabove, the present subject matter solves many problems associated with previous strategies, systems and/or devices. However, it will be appreciated that various changes in the details, materials and arrangements of components, which have been herein described and illustrated in order to explain the nature of the present subject matter, may be made by those skilled in the art without departing from the principle and scope of the claimed subject matter, as expressed in the appended claims.

What is claimed is:

1. A method of controlling the outflow of the amount of water required to form a given dose of a beverage obtained from ground coffee, accommodated in a filter, as the beverage is being dispensed into a cup, comprising a step of determining the total or target weight PT of the beverage to be dispensed into the cup, a step of determining the residual weight PR flowing into the cup after brewing water feeding has been stopped, wherein the method comprises an additional step of determining a stop weight PS at which the flow of the beverage brewing water is shut off, the stop weight PS being equal to PT minus PR and being stored in an electronic control unit to control brewing water shut off.

2. The method as claimed in claim 1, wherein the residual weight PR comprises at least one portion PSAT that is representative of the amount of water that is being measured and expressed in weight units during the time interval between actuation of delivery and the fall of the first drops of coffee into the cup.

3. The method as claimed in claim 1, wherein the determination of the residual weight is expressed as PR=0.1×PSAT, if the total or target weight PT of the beverage to be dispensed into the cup ranges from 40 to 90 grams of liquid.

4. The method as claimed in claim 1, wherein the determination of the residual weight is expressed as PR=0.16×PSAT, if the total or target weight PT of the beverage to be dispensed into the cup exceeds 90 grams of liquid.

5. The method as claimed in claim 1, wherein, if the total or target weight PT of the beverage to be dispensed into the cup is less than 40 grams of liquid, the value of the residual weight PR is calculated at the time the weight of the coffee in the cup reaches a predetermined percentage of the total or target weight PT of the beverage to be dispensed and the residual weight value PR is equal to the value of the total weight of the water delivered to that time, minus the saturation weight PSAT minus the weight of the coffee in the cup.

6. The method as claimed in claim 5, wherein the predetermined percentage is selected in a range from 60% to 75%.

7. An apparatus for controlling the outflow of an amount of water required to form a given dose of a beverage obtained from ground coffee, the apparatus comprising, in a machine for preparing coffee-based beverages, a panel for selecting the type of beverage to be dispensed into a cup, a hot water generator, an electric pump, a brewing unit, a flow meter located between the electric pump and the brewing unit, the electric pump being provided to feed hot water to the brewing unit, a valve device placed on a hydraulic connection between the electric pump and the brewing unit to shut off or actuate delivery of hot water, an electronic control unit, and a member for weighing the cup and its contents dispensed by the brewing unit, characterized in that the electronic control unit is configured to shut off delivery of hot water to the brewing unit as the weighing member receives a signal corresponding to the stored stop weight value PS which corresponds to the total or target weight PT of the type of beverage selected on the selection panel of the machine, minus the residual weight PR.

8. The apparatus as claimed in claim 7, wherein the beverage selection panel comprises buttons for selecting beverages having a respective total weight PT in the cup that is less than or equal to 40 grams of liquid, a total weight PT in the cup that ranges from 41 to 90 grams of liquid and a total weight PT in the cup that is equal to or more than 90 grams of liquid.
